(19) United States
(12) Patent Application Publication
(10) Pub. No.: US 2009/0229220 A1
(43) Pub. Date: Sep. 17, 2009

(54) BUILDING ELEMENTS AND SOFTWARE FOR USE IN AN BUILDING SYSTEM

(76) Inventor: Paul Gokkel, Bloemendaal (NL)

Correspondence Address: BROOKS KUSHMAN P.C., 1000 TOWN CENTER, TWENTY-SECOND FLOOR, SOUTHFIELD, MI, 48075, US

(21) Appl. No.: 11/816,842

(22) PCT Filed: Feb. 21, 2006
(86) PCT No.: PCT/NL06/00089

§ 371 Date: Aug. 22, 2007

(30) Foreign Application Priority Data
Feb. 22, 2005 (NL) 1028365

(51) Int. Cl. E04C 3/00; G06F 17/50; E04B 1/00

(52) U.S. Cl. 52/848; 703/1; 52/741.1

(57) ABSTRACT

A building system comprising rectangular strips, that can be attached to each other using tabs and notches. The building system uses software to simulate and print the models. The software manipulates similar rectangular strips. The surface of the rectangular strips, of the building system as well as the software, comprises a plurality of folding lines, regularly distributed over that entire surface. Each strip can be folded along these folding lines to become a curved surface in space. Several curved strips can be attached to each other to form a 3D-model, both physically with the building system as well as virtually with the software. The software can be used to print the model with an digital image. In particular one can deform an ordinary photo to a realistic 3D-image.

The present invention relates to a building system, comprising rectangular strips that are mutually connected at common binding edges using attachment means. Said strips are provided with tabs and notches at their binding edge. The software is used for the simulation of models built with this building system and the printing of the strips. Building systems using rectangular strips with tabs and notches are well known in the patent literature.

FR893964 describes rectangular sheets provided with tabs and notches that can be attached together. FR936384 also describes sheets with tabs and notches, regularly positioned at the edges of the sheets. These building systems, however, are not suitable to construct curved surfaces. The present invention has the purpose to provide for a building system that is particularly appropriate for making arbitrary curved three dimensional models.

To achieve the intended result the present invention is characterised by attachment means comprising tabs, regularly positioned on one or more binding edges of each strip. Between two neighbouring tabs there is situated a notch. During the building process, according to the present invention, the tabs of one strip are inserted into the notches of an adjacent strip to attach these strips. In this way a reliable attachment is attained, in which further connection means like glue are redundant.

A particular embodiment of the building system is characterised by tabs, comprising a main section projecting from an edge of the strip. Said main section possesses a proximal part, projecting from the edge of the strip, and a distal part with protrusions that leave open recesses at the proximal part. The binding is implemented by clenching the main section of the tabs of one strip into the recesses of an adjacent strip. each strip comprises a plurality of folding lines or creases, regularly distributed over the entire surface of said strip. The strip can be bent or folded along these folding lines to obtain a curved strip. Using a certain number of strips and attaching them together in an parallel and/or serial configuration, an arbitrary curved complex surface can be modelled.

For example this surface can have a spherical, cylindrical or cubical appearance, composed of successive bands or strips. But many other three dimensional models are possible.

The length and width of the rectangular strips can vary. Also the width of the main section of each tab is equal or slightly less than the width of the corresponding notches between these tabs. Thus the tabs of each strip fit exactly or with a minor tolerance into the corresponding notches of another strip. This elementary width must be a constant for all strips, used for building a specific model. This elementary width will be referenced to in the rest of this description. Also for clarity we assume in the rest of this description that the width of the main section of the tabs equals the width of the corresponding notches.

The software creates and uses similar virtual rectangles as ordinary CAD-building elements to design a model and print the corresponding physical rectangular strips with a desired pattern. These strips are afterwards assembled to a physical model.

Another preferred embodiment of the building system is characterised by strips that comprise a plurality of straight folding lines or creases, regularly distributed over the entire surface of said strip.

There are two types of folding lines. The first type of folding line is perpendicular to the longitudinal axis of the strip and the second type of folding line makes a certain fixed oblique angle with said first type of folding line. Each folding line starts from one longitudinal edge of the strip to the other longitudinal edge of said strip. More specifically, the folding line starts from a vertex of the main section of a certain tab, on the longitudinal edge, to a similar vertex of a tab on the other longitudinal edge. The strip can be bent along these folding lines to obtain a curved strip.

In this way each perpendicular folding line is surrounded by two adjacent triangles, between that perpendicular folding line and the two oblique folding lines, diverging from said perpendicular folding line.

These two adjacent triangles can be folded together at the perpendicular folding line, yielding a curvature of the strip at said folding line.

A preferred embodiment of a building element used in the present invention comprises on both the upper and the lower longitudinal edge a regularly spaced sequence of vertexes as described above and the following two types of folding lines:

The first type of folding line starts from a vertex, of the main section of an tab, situated on the upper longitudinal edge of the strip and ends on the corresponding vertex, precisely underneath said first vertex, on the lower longitudinal edge of the strip and is perpendicular to the longitudinal axis of the strip.

The second type of folding line starts from a vertex, of the main section of an tab, on the upper longitudinal edge of the strip and ends on a vertex on the lower longitudinal edge of the strip, that jumped one elementary width with respect to the vertex precisely underneath said first vertex. So this folding line makes an fixed oblique angle with respect to the first type of vertical folding line.

From all these vertices starts exactly one vertical folding line of the first type From a vertex starts either no folding line of the second type or two diverging skew folding lines of the second type. If two skew folding lines of the second type diverge from a specific vertex on the upper or lower longitudinal edge, then from both vertices, on the same longitudinal edge, adjacent to said first vertex no skew folding lines start. If no skew folding lines of the second type start from a specific vertex on the upper or lower longitudinal edge, then from both vertices, on the same longitudinal edge, adjacent to said first vertex, two skew folding lines diverge.

The software uses similar virtual rectangles as CAD-building elements. Each rectangle comprises a plurality of folding lines, regularly distributed over the entire surface of said rectangle. The rectangle can be bent along these folding lines to obtain a curved entity, Using several rectangles and attaching them together in an parallel and/or serial configuration, an arbitrary curved complex surface can be modelled on the computer.

In a preferred embodiment of the invention the software makes use of virtual rectangles in which both longitudinal edges comprise a sequence of regularly spaced vertices with a fixed elementary separation between any two neighbouring vertices. Each folding line starts from a vertex on one longitudinal edge of the rectangle to a vertex on the other longitudinal edge of said rectangle.

Just as with the physical building strips there are again two different types of folding lines: The first type of folding line is perpendicular to the longitudinal axis of the rectangle and the second type of folding line makes a specific fixed oblique angle with said first type of folding line.

From each vertex on the longitudinal edges starts exactly one vertical folding line of the first type, extending from that vertex to the corresponding vertex, precisely underneath or above said first vertex, on the opposite longitudinal edge of the rectangle.

The second type of folding line starts from a vertex, on the upper longitudinal edge of the rectangle and ends on a vertex on the lower longitudinal edge of the rectangle, that jumped one elementary separation with respect to the vertex precisely underneath said first vertex. So this folding line makes an fixed oblique angle with respect to the first type of vertical folding line.

From a vertex starts either no skew folding line of the second type or two diverging folding lines of the second type. If two skew folding lines of the second type diverge from a specific vertex on the upper or lower longitudinal edge, then from both vertices, on the same longitudinal edge, adjacent to said first vertex no skew folding lines start. If no skew folding lines of the second type start from a specific vertex on the upper or lower longitudinal edge, then from both vertices, on that same longitudinal edge, adjacent to said first vertex two skew folding lines diverge. In this way each perpendicular folding line is surrounded by two adjacent triangles, between that perpendicular folding line and the two oblique folding lines, diverging from said perpendicular folding line.

Such a rectangle can be bent along these folding lines to obtain a curved strip. More specifically each rectangle can be folded along one or more perpendicular folding lines, yielding a curved or a cylindrical surface.

Also two adjacent triangles can be folded together at the perpendicular folding line, yielding a curvature of the rectangle at said folding line.

More specifically if two skew folding lines diverge from a certain vertex, on one of the two longitudinal edges, with a perpendicular folding line between them, both exterior parts of the rectangle outside the pair of triangles that are bounded by said skew folding lines and said perpendicular folding line, are rotated about said vertex until both skew folding lines coincide.

An arbitrary rectangle can comprise several pairs of its triangles folded together in this way to attain a flat polygonal shaped strip.

As the software constructs a sliced model or more specifically a model, built of several sliced subparts, each comprising a number of bands of varying widths but each with the same elementary separation between two neighbouring vertices for a connected subpart, all the bands consisting of rectangles must be properly aligned to respective parallel reference planes. Therefore the above mentioned polygonal strip must be aligned with its outer edges to one of the reference planes.

Suppose the reference plane is chosen so that it intersects one of the vertices on the outer periphery of the polygonal strip. The entire polygon is then rotated about this vertex until one of the straight outer edges, adjacent to this vertex, lies in this reference plane. If the polygonal strip is perpendicular to the reference plane, one can rotate the entire polygonal strip slightly about this last mentioned edge, so that the plane of the flat polygonal is no longer orthogonal to the reference plane. Now the outer edge, adjacent to the last mentioned outer edge can be aligned to coincide with said reference plane. This is realised through folding the flat polygonal along the perpendicular folding line that projects from said vertex and the first mentioned outer edge. By repeating the same procedure one can align the entire polygonal, that is now of a (partial conical) shape, with its outer edge to said reference plane. Automatically the inner edge of the polygon is also aligned now to a plane parallel to said reference plane.

Alternatively the same procedure can be applied to one of the inner vertices and its adjacent straight inner edge. For this alignment procedure the program can make use of standard CAD-tools like snapping on a point, line or plane.

After this alignment procedure both longitudinal edges of the polygonal curved strip reside in parallel reference planes and new strips can be adjoined to them.

The physical rectangular strips used in the building system can be folded and aligned by hand to connect new strips to both longitudinal edges of them.

If one uses the software to construct a model, this model can be given a texture with the standard CAD rendering tool that projects a digital image onto the model. This projection tool projects each pixel from the image or digital photo from a certain origin onto the model.

A preferred embodiment of the invention comprises software with such a projection tool. With this projection tool one can provide a model with an image and change the shape of the model successively. These steps can be repeated if desired. So one obtains a real time rendering.

With this tool it is possible to deform an ordinary digital image or photo to a realistic 3D-photo on the computer One can regain the original depth of a photo or digital image of a 3D-object by repeated projection of that digital image or photo on a self constructed approximation of that 3D-model alternated with an adjustment of the shape of that 3D-model on the PC.

Another preferred embodiment of the invention comprises rectangular strips that are temporarily attached to each other and form a rectangular sheet together. This can be achieved by partially punching the tabs and notches of the rectangular strips.

A preferred embodiment of the invention is characterised by rectangular strips that are made of thin material like plastic foil, metal foil, paper, cardboard etc.

Still another embodiment of the invention comprises software that saves the part of the image used for each curved rectangle. The curved rectangles belonging to the model including their images are flattened again and the triangles, folded together, are unfolded again. Next the images are sorted to be prepared for printing on the above mentioned rectangular sheets provided with rectangular strips.

Each such sheet can comprise only a limited number of different rectangular strips, that have a specified width. The software sorts the images according to the position and width of each strip on the sheet, so that the correct strip is printed with the image belonging to it.

Finally after the printing the physical strips can be removed from the sheet and assembled together to form a realistic representation of the computer model.

The present invention will be further elucidated here below with reference to the annexed figures of several design examples.

FIG. 1 a top view of an design example of a rectangular strip according to the invention

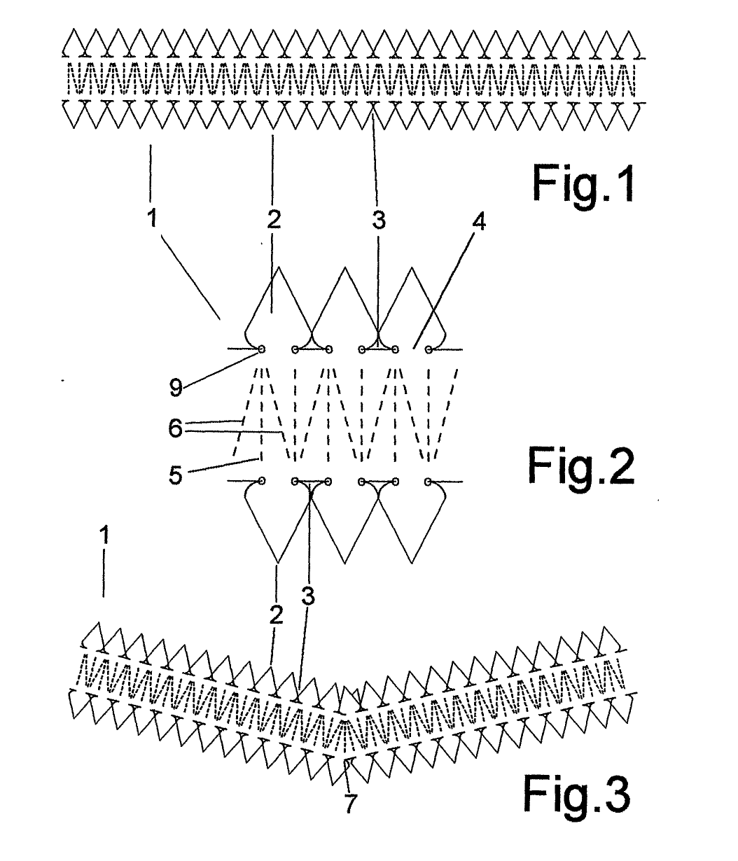

FIG. 2 a enlarged top view of a design example of the tabs and notches of a rectangular strip according to the invention.

FIG. 3 a top view of a rectangular strip, folded together at a certain position.

FIG. 4 a top view of a rectangle used in the software according to the invention.

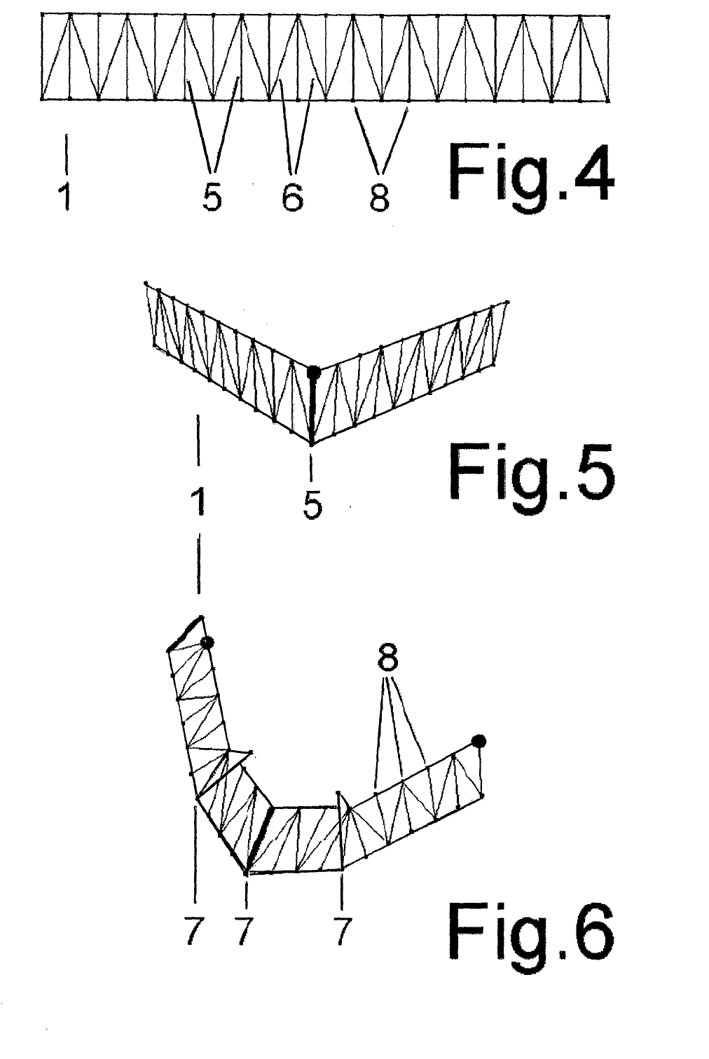

FIG. 5 a perspective view of a rectangle bent at a perpendicular folding line.

FIG. 6 a perspective view of a rectangle folded together at three positions to a polygonal shaped strip.

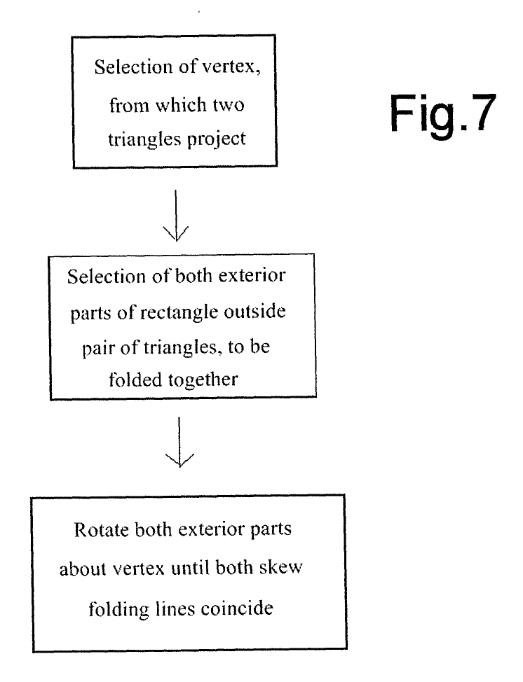

FIG. 7 flowchart of the software module for the folding together of rectangles.

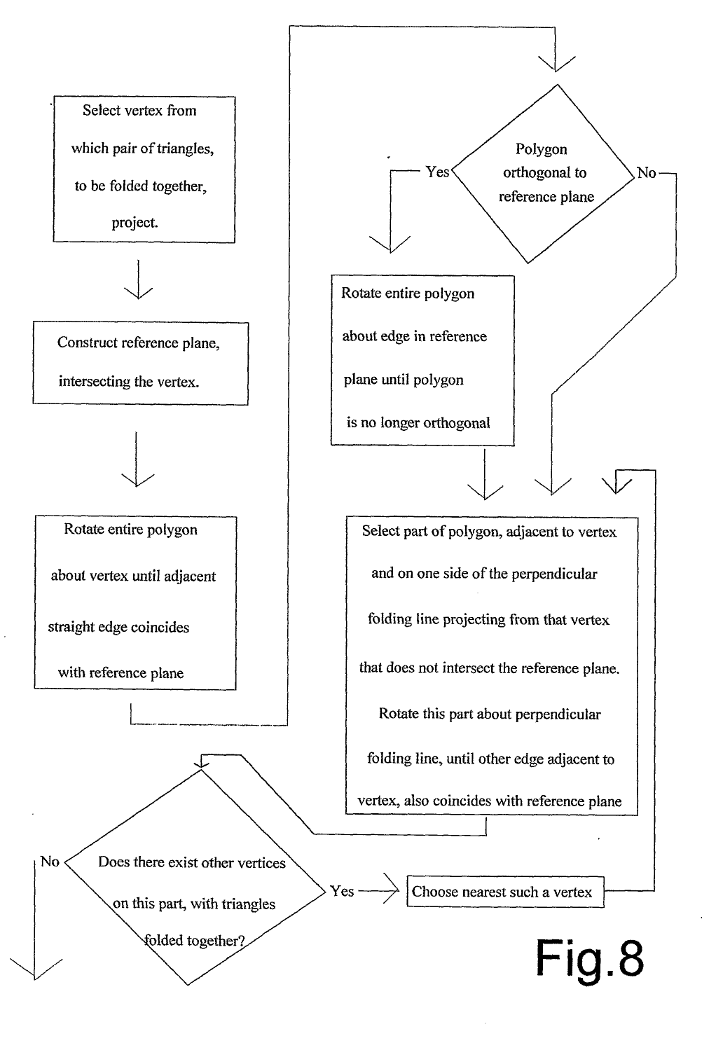

FIG. 8 flowchart of the software module for the alignment of polygonal shaped strips to a reference plane.

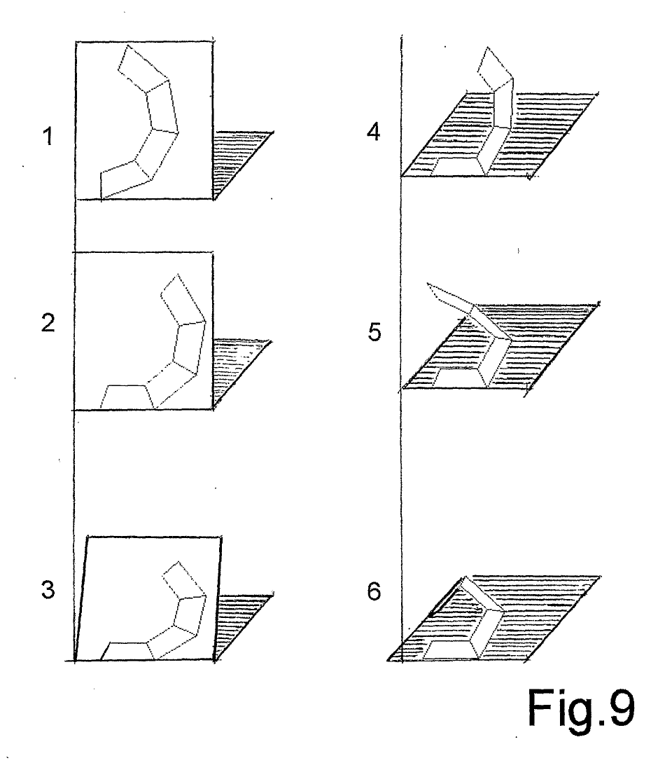

FIG. 9 perspective view of the successive stages of the alignment process.

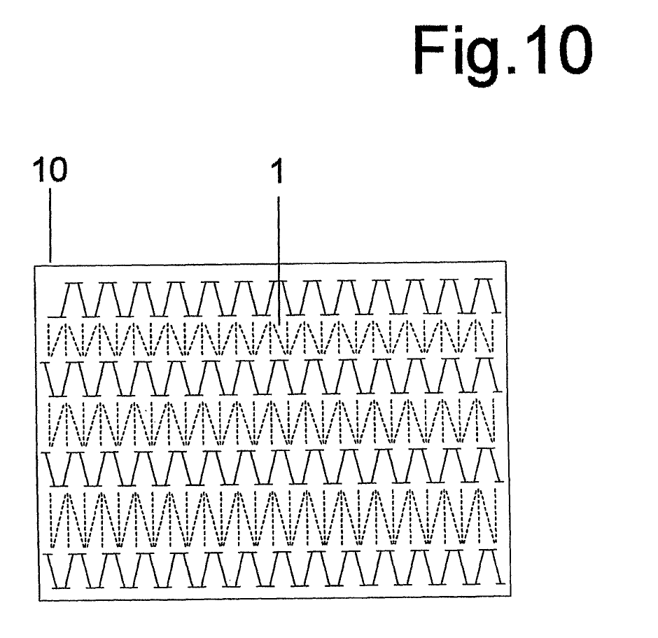

FIG. 10 Top view of a design example of a sheet composed of several temporarily attached rectangular strips.

The figures are otherwise schematic and not drawn to scale. For the sake of clarity some dimensions, in particular, may be exaggerated to a greater or lesser extent. Corresponding parts are designated, as far as possible, in the figures with the same reference numerals.

FIG. 1 depicts a rectangular strip 1 according to the invention that on both its longitudinal edges comprises an alternating sequence of tabs 2 and notches 3. Each strip 1 also comprises a plurality of folding lines like perforated lines or creases, regularly distributed over the entire surface of said strip 1, These folding lines are depicted as dashed lines in this figure. There are two types of folding lines: The first type is a perpendicular folding line 5 that is orthogonal to the longitudinal axis of the rectangular strip 1. The second type of folding line is a skew folding line 6. The strip 1 can be bent or folded along these folding lines to obtain a curved strip 1.

FIG. 2 shows an enlarged view of a section of this same rectangular strip 1. Each tab 2 comprises a main section 4 projecting from the longitudinal edge of the rectangular strip 1. The width of this main section 4 is equal to, or slightly less than ( to facilitate its insertion), the width of the notch 3 at the level of the longitudinal edge. In this figure these widths are equal for simplicity. Thus the extremities 9 of the notches 3 coincide with the extremities 9 of the main sections 4 in this case, and are regularly distributed over both longitudinal edges of the strip 1, with a fixed separation between any two neighbouring extreme points 9. These extreme points 9 are marked with an o for sake of clarity. From each such extreme point 9 diverges exactly one folding line 5 which is perpendicular to the longitudinal edge of the strip 1. From an extreme point 9 starts either no skew folding line 6 of the second type or two diverging folding lines 6 of the second type. The sequence of extreme points 9 on each longitudinal edge comprise alternately extreme points 9 with no diverging skew folding lines 6 and extreme points 9 with exactly two diverging skew folding lines 6.

In this way each perpendicular folding line 5 is surrounded by two adjacent triangles, between that perpendicular folding line 5 and the two adjacent skew folding lines 6, diverging from said perpendicular folding line 5.

In FIG. 3 depicts a rectangular strip 1 according to the invention in which two adjacent triangles, at the position denoted by 7 on the strip, have been folded together at the perpendicular folding line 5, yielding a curvature of the rectangle at said position 7.

FIG. 4 shows a top view of a rectangular building element 1 used in the software according to the invention. Apart from the tabs 2 and notches 3 this building element 1 has an identical shape as the rectangular strip 1 depicted in FIG. 1 and FIG. 2. Each rectangular building element comprises a sequence of vertices 8 that are regularly distributed over both longitudinal edges of the element 1, with a fixed separation, and a standard CAD line segment, between any two neighbouring vertices 8. From the first and the last vertex 8 on a longitudinal edge of the rectangular building element 1 projects a line segment that is orthogonal to said longitudinal edge and forms the short edge of the rectangle 1.

This building element 1 also comprises a plurality of folding lines regularly distributed over the entire surface of said element 1. Each folding line is implemented here as an ordinary CAD line segment. There are again two types of folding lines: The first type is a perpendicular folding line 5 that is orthogonal to the longitudinal axis of the rectangular element 1. The second type of folding line is a skew folding line 6. The rectangular building element 1 can be bent or folded along these folding lines to obtain a curved strip 1. From each vertex 8 projects exactly one folding line 5 which is perpendicular to the longitudinal edge of the rectangular element 1. From an vertex 8 starts either no skew folding line 6 of the second type or two diverging folding lines 6 of the second type. The sequence of vertices 8 on each longitudinal edge comprise alternately vertices 8 from which project no diverging skew folding lines 6 and vertices 8 from which project exactly two diverging skew folding lines 6.

FIG. 5 depicts a perspective view of a rectangular building element 1, used in the software, that is bent at a perpendicular folding line 5 to a strip 1 with a longitudinal axis that is now V-shaped in space.

FIG. 6 shows a perspective view of a rectangle 1 folded together at three positions 7 to a polygonal shaped strip 1. Each pair of triangles, folded together at these positions 7, is protruding outwards from the strip 1 as is shown in this figure.

FIG. 7 depicts a flowchart of the software module for the folding together of rectangles 1 at a certain vertex 8.

FIG. 8 shows a flowchart of the software module for the alignment of a polygonal shaped strip 1 to a reference plane. With this module a flat polygonal shaped strip 1 is folded at the perpendicular folding lines 5, from which the two adjacent triangles are folded together, and simultaneously aligned to a flat reference plane with its bottom or top edge coinciding in that reference plane. In this way a longitudinally and transversally curved surface in space is obtained.

FIG. 9 depicts a perspective view of the successive stages of this alignment process.

In sub-picture 1 of this figure a flat polygonal shaped strip resides in the front plane.

In sub-picture 2 this polygonal strip is rotated in this front plane about its left-hand bottom vertex until the left-hand bottom edge coincides with the shaded bottom plane.

In sub-picture 3 the front plane inclusive the flat polygonal strip is rotated about its bottom edge to a tilted position with respect to the shaded bottom plane.

In sub-picture 4 the second segment, from the left, of the polygonal strip is aligned, with its bottom edge coinciding with the shaded bottom plane.

In sub-picture 5 the third segment, from the left, of the polygonal strip is aligned, with its bottom edge coinciding with the shaded bottom plane.

In sub-picture 6 the last segment of the polygonal strip is aligned, with its bottom edge coinciding with the shaded bottom plane.

FIG. 10 shows a top view of a design example of a sheet 10 composed of several temporarily attached rectangular strips 1, This temporary connection can be attained by a partially punching out of the strips 1 from the sheet 10. In this way the separation between different strips 1 is formed by either a perforated cutting-line or a separation line using a cutting of the sheet material that does not completely penetrates that sheet material. During the printing the strips 1 are connected to each other, but afterwards they can be removed from each other by hand.

Although the invention was illustrated further using some embodiments, the present invention is certainly not limited to these. On the contrary, for the average professional, within the scope of the invention, many other variations and designs are possible. The sizes, shapes of the building elements can vary if desired.

1. Building system comprising rectangular strips, with tabs and notches projecting from the edges, with which they can be mutually attached and each such strip is characterised by a plurality of straight folding lines, in particular perforated lines or creases, that are regularly distributed over the entire surface of said strip.

2. CAD-software that comprises and manipulates rectangular strip-like building elements characterised by a plurality of straight folding lines, that are regularly distributed over the entire surface of said building element.

3. Building system according to claim 1 that is characterised by rectangular building elements with longitudinal edges that comprise a sequence of vertices with a fixed separation between any two neighbouring vertices and from each such a vertex a folding line starts or ends.

4. Building system according to claim 3 comprising rectangular building elements, that are characterised by perpendicular folding lines that are orthogonal to the longitudinal edges of the rectangle and that start from a certain vertex on the upper longitudinal edge and end on the vertex on the lower longitudinal edge of the rectangle, precisely beneath said first vertex.

5. Building system according to claim 4 comprising rectangular building elements, that are characterised by skew folding lines that make an oblique angle with respect to the perpendicular folding lines mentioned in claim 4 and start from a vertex on the upper longitudinal edge and end on a vertex on the lower longitudinal edge, neighbouring the vertex on the lower longitudinal edge that is exactly underneath said first vertex.

6. Building system according to claim 4 comprising rectangular building elements, that are characterised by vertices on the longitudinal edges from which project either no skew folding line or two diverging skew folding lines as mentioned in claim 5, and if two skew folding lines diverge from a specific vertex on the upper or lower longitudinal edge, then from both vertices, on the same longitudinal edge, neighbouring to said first vertex no skew folding lines start, and vice versa.

7. Building system according to claim 4 comprising rectangular building elements, that are characterised by vertices on the longitudinal edges of the rectangles from which always exactly one perpendicular folding line mentioned in claim 4 projects.

8. Building system according to claim 4 that is characterised by rectangular building elements with pairs of adjacent triangles, bounded by the above mentioned perpendicular and skew folding lines and said triangles can be folded together at their mutual perpendicular folding line, yielding a curvature of the rectangle at said folding line.

9. Building system according to claim 8 that is characterised by rectangular strip-like building elements that can be deformed, by repetition of the procedure mentioned in claim 8, to a flat strip with a polygonal shaped outer edge.

10.-11. (canceled)

12. Building system according to claim 1 that is characterised by rectangular strips that are temporarily attached to each other, implemented by a partially punching out of the tabs and notches of said strips, and form a rectangular sheet together, which can be printed, using an ordinary printer, with an image that is generated with the software of the present invention, whereby before the printing process, said software sorts the images residing on the different curved rectangles of the model and adapts them to the configuration of strips on said rectangular sheet.

13. CAD-software according to claim 2 that is characterised by rectangular building elements with longitudinal edges that comprise a sequence of vertices with a fixed separation between any two neighbouring vertices and from each such a vertex a folding line starts or ends.

14. CAD-software according to claim 13 comprising rectangular building elements, that are characterised by perpendicular folding lines that are orthogonal to the longitudinal edges of the rectangle and that start from a certain vertex on the upper longitudinal edge and end on the vertex on the lower longitudinal edge of the rectangle, precisely beneath said first vertex.

15. CAD-software according to claim 14 comprising rectangular building elements, that are characterised by skew folding lines that make an oblique angle with respect to the perpendicular folding lines mentioned in claim 4 and start from a vertex on the upper longitudinal edge and end on a vertex on the lower longitudinal edge, neighbouring the vertex on the lower longitudinal edge that is exactly underneath said first vertex.

16. CAD-software according to claim 14 comprising rectangular building elements, that are characterised by vertices on the longitudinal edges from which project either no skew folding line or two diverging skew folding lines as mentioned in claim 5, and if two skew folding lines diverge from a specific vertex on the upper or lower longitudinal edge, then from both vertices, on the same longitudinal edge, neighbouring to said first vertex no skew folding lines start, and vice versa.

17. CAD-software according to claim 14 comprising rectangular building elements, that are characterised by vertices on the longitudinal edges of the rectangles from which always exactly one perpendicular folding line mentioned in claim 15 projects.

18. CAD-software according to claim 14 that is characterised by rectangular building elements with pairs of adjacent triangles, bounded by the above mentioned perpendicular and skew folding lines and said triangles can be folded together at their mutual perpendicular folding line, yielding a curvature of the rectangle at said folding line.

19. CAD-software according to claim 18 that is characterised by rectangular strip-like building elements that can be deformed, by repetition of the procedure mentioned in claim 19, to a flat strip with a polygonal shaped outer edge.

20. CAD-software according to claim 19 that is characterised by including an alignment tool to align the outer or inner polygonal edge of the strip mentioned in claim 20, as described in the description of this patent.

21. Usage of the software according to claim 2 for regaining the original depth of a photo or digital image of a 3D-object by repeated combined projection, of that digital image or photo on a self constructed approximation of that 3D-model, and adjustment of the shape of that 3D-model on the PC.
